(19) United States
(12) Patent Application Publication
(10) Pub. No.: US 2010/0282762 A1
(43) Pub. Date: Nov. 11, 2010

(54) Mobile Insulin Storage Cooler (MISC)

(76) Inventor: Larry Wendall Leonard, Edmonds, WA (US)

Correspondence Address: Eli Weiss, Esq.;Oakwood Law Group, LLP, 14 Bond Street -- SUITE 386, Great Neck, NY, 11021, US

(21) Appl. No.: 12/777,256

(22) Filed: May 10, 2010

Related U.S. Application Data
(60) Provisional application No. 61/215,865, filed on May 11, 2009.

(51) Int. Cl. B65D 81/18; A61J 1/14; B65D 81/38; B65D 88/74

(52) U.S. Cl. 220/592.01; 220/592.2

(57) ABSTRACT

A bottle for cooling or warming a bottle of insulin having a first bottle of an insulating material for receiving a liquid or solid cooling or warming medium having at its top end male threads for receiving a screw on cup shaped cover and a second bottle of non-insulating material located within the first bottle. The second bottle has a size that can receive a 10 ML volume bottle of insulin that is to be kept at a temperature of between 36 degrees F. and 87 degrees F. by the cooling or warming medium in the first bottle for extending the storage life of insulin in the bottle which is located in the second bottle.

### REFERENCE TO RELATED APPLICATIONS

This patent application claims the benefit of U.S. Provisional Application

No. 61/215,865 filed on May 11, 2009, the disclosure of which is incorporated herein in its entirety by reference.

### BACKGROUND OF THE INVENTION

1. Field of the Invention

The present invention relates to portable containers for transporting vials of insulin and more specifically protecting them from environmental damage by transporting the vials of insulin in a temperature controlled environment.

2. Description of Related Art

Insulin, while being transported must be kept cold but should not be frozen to be effective. A portable device for transporting insulin is known in the prior art. More specifically, by way of example, U.S. Pat. No. 6,044,650 to Cook, et al. discloses a container for storing and transporting vessels containing a liquid composition susceptible to physicochemical alteration upon changes in temperature above or below a specified temperature. It comprises an enclosure having a lower portion, a top portion and a side portion between the lower and top portions which define an inner space. A lower portion of the enclosure contains a first heat sink within a base which has a thermal energy absorbing substance. A vial holder in the inner space holds a vessel in the inner space above the first heat sink and substantially spaced from an insulated insert inside of the enclosure. An insulating gas is contained in the inner space. A temperature indicator in the inner space indicates when the inner space has been subjected to temperatures below a predetermined level.

U.S. Pat. No. 5,956,968 to Grabowski discloses a portable cold pack which has a hollow, thin-walled housing and a base having a socket depression therein for receiving a holder. The housing and the base define an interior storage space around the holder. The hollow walls contain refreezable liquid for providing cooling energy. The socket depression orients the holder in the storage space in a close relationship to the interior surface of the hollow, thin-walled housing to cool a medicine within a vial.

U.S. Pat. No. 5,865,032 to MacPherson, et al. discloses a portable thermoelectric-cooling medicine kit for insulin which is cooled by a Peltier heat pump.

U.S. Pat. No. 5,390,791 to Yeager discloses a hollow, thin walled medicine carrier. The carrier is substantially filled with a paraffinic hydrocarbon such as Hexadecane, an alpha olefin, or a material such as Dimethyl Sulfoxide. A cavity in a top surface of the carrier is formed from a plurality of different semi-circular compartments which allows the carrier to accept medicine vials of differing sizes.

U.S. Pat. No. 5,216,900 to Jones discloses a soft-sided cooler having a pivotably fastenable lid and a soft-sided coolant pack which fits within the underside region of the lid. The cooling pack has a matrix of coolant cells integrally formed within a compliant plastic sheet, and inserted within a fabric envelope.

U.S. Pat. No. 4,848,587 to Nipp discloses an openable rectangular box having a first longitudinal compartment that runs the entire length of the box for receiving packaged sterile syringes. A second longitudinal compartment for storing sterilizing swabs or wipes in sealed packages. Between this second compartment and the far end of the box is a third compartment for holding glucose test tapes, and in the remaining space are two compartments for receiving upright insulin bottles or the like.

U.S. Pat. No. 4,343,158 to Campbell discloses a portable, flexible, refrigerating pouch for carrying and storing insulin. The pouch has an insulating layer and a liner whose structure provides separate compartments for a refrigerating agent, a vial of insulin and a syringe.

U.S. Pat. No. 4,322,954 to Sheehan, et al. discloses an insulative housing containing a coolant compartment and a medicine compartment, each having its own lid, and heat sinks in the compartments thermally connected by a heat tube. Water ice, dry ice, or a chilled gel may be utilized as the coolant. The whole assembly is enclosed in a small carrying case.

### SUMMARY OF THE INVENTION

In an exemplary embodiment of the present invention, there is disclosed a bottle for cooling or warming a bottle of insulin having a first bottle of an insulating material for receiving a liquid or solid cooling or warming medium having at its top end male threads for receiving a screw on cup shaped cover and a second bottle of non-insulating material located within the first bottle. The second bottle has a size that can receive a 10 mL volume bottle of insulin that is to be kept at a temperature of between 36 degrees F. and 87 degrees F. by the cooling or warming medium in the first bottle for extending the storage life of insulin in the bottle which is located in the second bottle.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1A: shows the top of the insulin chamber is sealed using a Hinge and Clip Lock Down Plug as compared to FIG. 5A as an alternate Chamber Screw Plug Seal. Preferred FIG. 1A is similar to FIG. 5A as it shows how the insulin bottle 10 is to be inserted into chamber 16.

FIG. 1B is an exploded view of the preferred bottle with a finish top cup that is screwed on snug after the male end of FIG. 1A is inserted into chamber 24 then sealed by using thread, sealer gasket, and compression edge.

FIG. 1C is a cross section through 12, 33, 34 and the housing that holds it inside.

FIG. 1D is a top view of a temperature gauge that monitors the temperature inside the insulin chamber number 16.

FIG. 1E is a perspective view of the invention with all the parts assembled and ready to travel.

FIG. 1F is a perspective view of a standard thermal bottle plug with no male part hanging down like FIG. 1A or FIG. 5A.

FIGS. 2A and 2B are exploded perspective views of the complete and the lower half bottom of multiple wall vacuum sealed stainless steel thermal bottle with top cup cap and seal of Liquid Thermal Mass Cooling Chamber. The bottom of the bottle is modified for the purpose of convenient and unobvious mobile-insulin-cool-storage. It is a bottom insulin entry system for quick load and retrieve of insulin bottles to and from a built-in insulin cooling storage chamber separate from liquid chamber.

FIG. 2C is a cross section exploded view of FIG. 2A with the bottom and top units screwed off and just beginning to separate to make three separate parts as top cap, middle bottle, and bottom cap.

FIG. 2D is a cross section of the thermal bottle without the top and bottom cap as seen in FIG. 2C.

FIG. 3A is a perspective View of a thermal bottle having a recessed air tight sealed medicine cabinet with door It is a side insulin wall entry system for quick load and retrieve of insulin from the insulin cooling chamber that is located right next to the Thermal Transport Cooling Wall.

FIG. 3B is a cross section view through FIG. 3A with the door to the insulin chamber shut.

FIG. 3C is a cross section view through FIG. 3A with the door to the insulin chamber open.

FIG. 4A is a perspective view of a multiple wall vacuum sealed stainless steel pocket size tube or larger multiple use size thermal bottle or it is similar looking to a test tube to carry medicine bottles preferably insulin bottles in the size range 0.50 mL to 10 mL with a top cup cap and seal. A plug top can be used, if space allows

FIG. 4B is a front view of FIG. 4A with non-preferred locking method:

FIG. 4C shows a locking method of cap 36 with cap almost off.

FIG. 4D is a cross section of FIG. 4C with no locking devise.

FIG. 4E is a bottom view of the cap.

FIG. 4F is a partial side View of FIG. 4B detailing the slide lock retracted, unlocked.

FIG. 4G is a partial side view of FIG. 4B detailing the slide lock extended, locked.

FIG. 5A is another embodiment showing one of many possible ways to alter closure of opening of FIG. 1A. The insulin chamber in FIG. 5A is shut using a screw, gasket, and compression method where FIG. 1A is a hinge lid seal and close method. The temperature gauge is inserted into the screw plug FIG. 5A to monitor temperatures in the chamber once it's sealed shut.

FIG. 5B is a cross section of FIG. 5A.

### DESCRIPTION OF THE PREFERRED EMBODIMENT

### Drawing

### Reference Numbers

10 Insulin Bottles 10 mL to 0.50 mL more or less
11 Chamber Screw Plug Seal
12 Temperature Monitoring Gauge
13 Screw Threads mate with 15
14 Gasket Seal for 11 Plug
15 Screw Threads mate with 13
16 Insulin Storage Chamber
17 Liquid Mass Plug Sealer
18 Screw Threads mate with 22
19 Gasket Seal mates 23
20 Water Measure Line Ruler
21 Angular Gasket Compression Ledge
22 Threads mate with 18
23 Angular Gasket Compression Ledge
24 Liquid Mass Cooling Chamber
25 Threads mate with threads 50
26 Vacuum Sealed Atmosphere
27 Vacuum Sealed Stainless Steel Thermal Bottle, Multiple Wall.
28 Hinge and Clip Lock Down Plug
29 Clip Lock, button spring loaded
30 Clip Lock Receiver-Female
31 Bulb Seal Gasket
32 Gasket Compression Ledge
33 Insulation and Air Seal
34 Thermal Expand and Contract Coil
35 Standard Bottle Screw Plug
36 Bottle Cap and Seal
37 Bottle Rim Edge
38 Bottom-up Built-In Insulin Chamber
39 Bottom Threads mate with 42
40 Heat Seal Cap
41 Finish Cap
42 Bottom Cap Threads
43 Bottom Cap
44 Gasket Seal of Insulin Chamber #38
45 Optional: Air Filter and Bottle Vent
46 Optional: Supply to Insulin Pump
47 Optional: Insulin Supply Needle
48 Optional: Vent Stack Needle
49 Bottle's Bottom Rim Edge
50 Threads mate with 25
51 Friction Holder. 53 Removable
52 Finish Cover, over heat cap
53 Cap Gasket to seal rim edge 37
54 Air Release Hole, before sealed
55 Thermal Wall and Cool Chamber
56 Frig. Door Insulator and Seal
57 Magnet
58 Door Grab Edge
59 Self Closing Axle and Spring Hinge
60 Compression Edge mates 56
61 Magnet Mass, not corrosive
62 45 Degree Edge for ease to 58
63 Sealed rim edges to maintain 26
64 Blank
65 Underpass Slide Guide
66 Slide Lock with Ball Tip
67 Metal Thermal Mass or Liquid Filled Bottle Cooling Mass
68 Receiver Slots for 66 and 71 Tips
70 Cup and Cover, Screw on and off
71 Male Key Pin
72 Key and Pin Body
73 Flange
74 Bottle Key Slot
75 Bottle Bump Over Ridge
76 Key Part melded with 72
77 Part 76 Bump Ridge
78 Lifts 71, 72, 73, 76, and 77
79 ID threads of 78 or One ID Bump Ridge
80 OD Bottle Threads or Two OD Bottle Bump Ridges
81 Tube ID Receives
82 Bottom Tube Threads fits into 81
83 Push On Cap
84 Imbedded ID Ring Gasket
85 Insulin Rubber Cap Seal

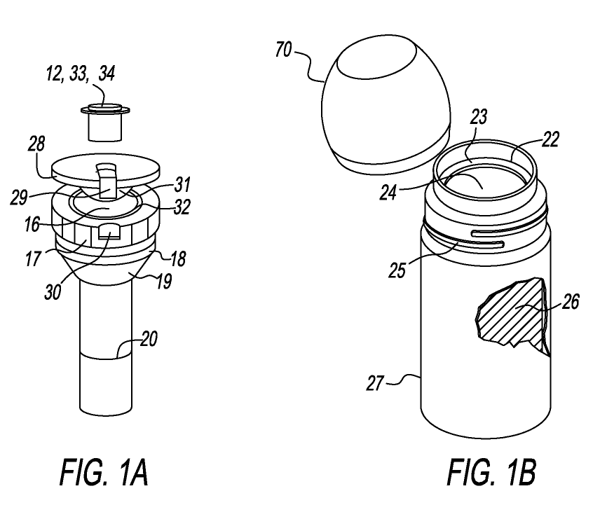

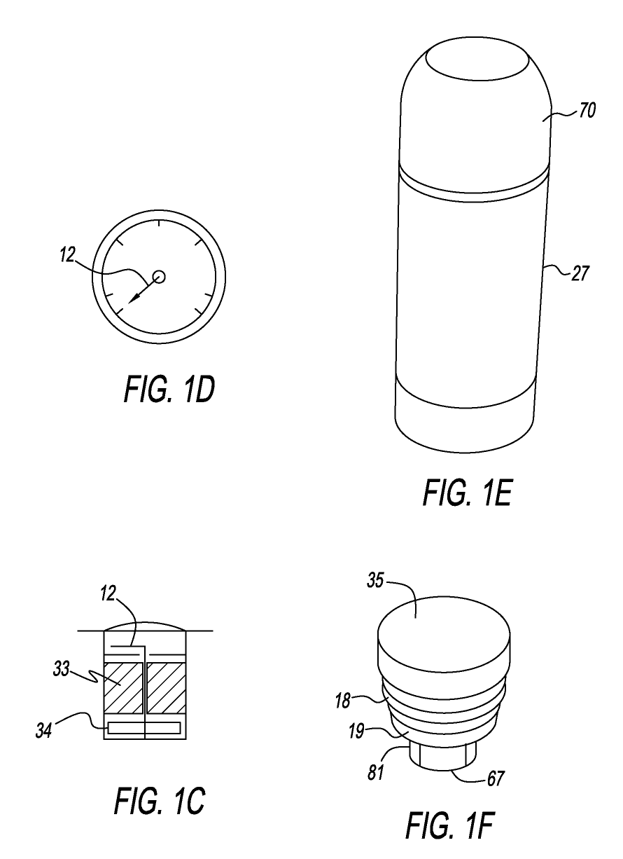

The preferred embodiment of the invention Mobile Insulin Storage Cooler (MISC) is illustrated in FIGS. 1A to 1 F.

Make It

FIG. 1A is an inventive bottle insert part that makes the invention process work screwed into chamber 24 of FIG. 1B that has cooling or warming medium inside.

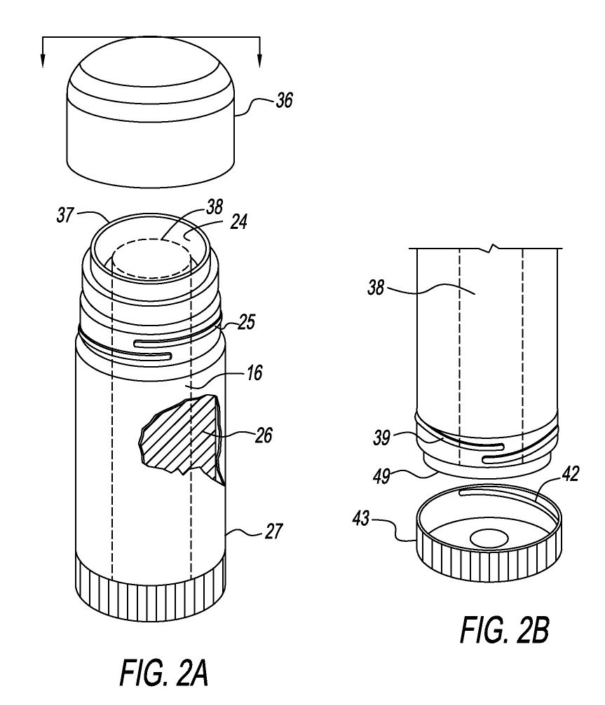

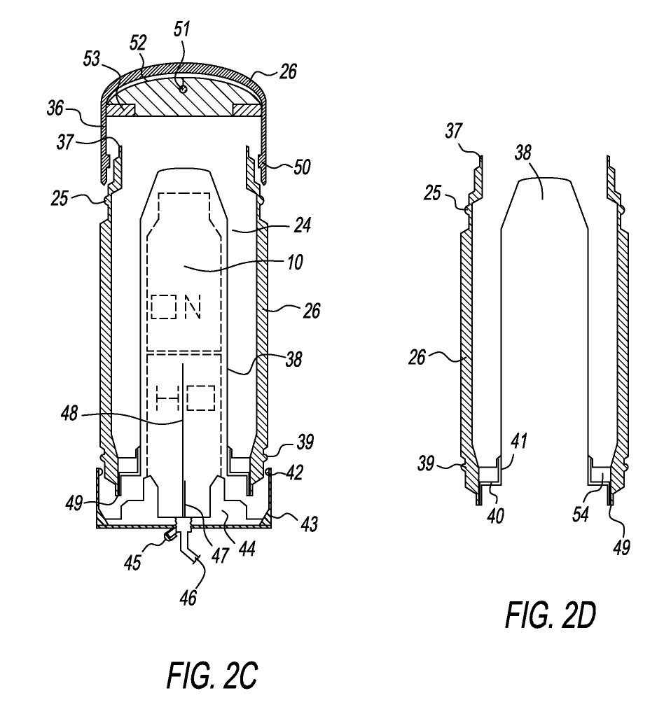

FIG. 1B is any fitting, new, and/or adaptable or existing bottle that has ability to be carried in one or two hands by reasonably healthy people with normal coordination. Preferred FIG. 1B bottle is the thermal enduring double or triple or multiple wall Stainless Steel Vacuum Sealed Insulating Thermal Bottle like or similar to FIG. 1B that stores any safe useable cool or warm mass liquids and/or solids, preferably water, at recommended temperatures for the purpose of enduring storage life of insulin in bottles, insulin pens, insulin pen cartridges, and/or various other insulin products that are available, or alternate uses to extent the life of human or animal tissue, cells, and parts, and other medicines beneficially maintainable at cool, warm, or recommended insulated temperatures, preferably, for as long as possible in the bottle until it's ready to be used. FIGS. 1B and 2A are the preferred stainless steel multiple wall vacuum sealed bottles because of their long lasting superior insulating qualities without the need of bulky insulation to keep stored items cool. The SS bottle is compact and it looks good in public as a SS bottle. The SS bottle is not broadcasting to everyone that it's a medical storage devise. The SS bottle is socially acceptable because it's hardly noticeable as anything different than the usual day or daily use coffee or juice or similar thermal bottle.

It is also possible for short term cooling or warming use needs of (MISC) FIG. 1A where the bottles do not need to have long extended lasting thermal qualities because of the customer's specific term travel need(s) with a (MISC) were any fitting bottle or bottles made of any bottle material or plastic, glass, single or multiple walls will do, or any fitting hand held portable bottle will serve the cooling need(s) long enough to satisfy travel time needs before re-cooling is necessary. Bottles can be enhanced by outside bottle insulation added and/or removable as need be like a thermal bottle insulating bag or a bottle slip-on foam insulator cozy with or without zipper, pouches, etc.

FIG. 1A is made of any material(s) that will conduct cold or warm temperatures from chamber 24 then thru the walls of the insulin chamber 16 at a rate sufficient to constantly cool or warm but not freeze the bottle of insulin inside chamber 16 to about or equal to the temperatures maintained and managed in chamber 24 of FIG. 1B at insulin storage temperatures of, but not limited to preferably, 36 to 87 more or less, or MD recommended temperatures using the preferred chamber 16 material, plastic, that is waterproof. preferred material for making 16 chamber is same as plastic sports bottles and/or plastic pop bottles. Also, PVC pipe material or similar qualities of material for making FIG. 1A is ok.

Wall thickness of chamber 16 to be anything sufficient to cause timely and sufficient cooling conductivity and it will also be semi-insulating with surface finishes that discourage condensation events and wall thickness will have durable wall quality favorable for insulin chamber 16 storage wall where such wall is preferred to be about 1/16 more or less inches thick.

Any hole diameter, length, or multiple hole chamber combinations that stores one insulin product or multiple insulin products can be used as long as it is desirable to the customer's diabetic needs and as long as 16 can be made to fit into chamber 24 yet Chamber 16 will have a preferred hole size of 15/16 more or less inches in diameter and it will be a 6⅜ inches deep hole to preferably accommodate three standard size 10 mL volume insulin bottles plus chamber will hold a preferable top foam rubber insulating top layer plug insulator located in the top part of chamber 16 and it all seals shut using 28, 29, 31, and 32.

The preferred method to make and manufacture plastic bottles, vacuum sealed multiple wall stainless steel thermal bottles and the parts that go with them will be accomplished by any person skilled in the art to which the invention pertains. I see by observation that the single or multiple wall bottles have (plastic or metal) semi-unnoticeable seams as separate parts welded, glued, heated, and/or melded and sealed together waterproof to become one finished part and then that part is sometimes melded again with another part, etc. and finish capping occurs in many ways and places to hide seams were the human eye is most focused. Observing FIG. 1A, I see making two separate molded plastic parts then each part will be seamed or melded together to become one part that is waterproof in making the part comprising numbers 32, 18, and 20 and it's surfaces just under the finish cap of 17. 17 is preferably a one part plastic molded finishing top cap permanently sealed and attached to the upper top area numbered 32, 18 and its surfaces just under the cap of 17.

FIG. 1A threads 18 will tighten down the plug and screw with FIG. 1B 22 threads and waterproof seal compression gasket 19 against 23 flange (gasket 19 is rubber band soft and removable). Gaskets will be supplied by or custom made and fitted by any person skilled in the art of making 19 and 31 gasket parts. Gasket 31 and 19 will be made durable and air and waterproof tight when tightened shut and/or clipped shut using 29 and 30 or screw sealed using 18, 22, 19, and 23 screw threads and gaskets.

The finish cap 17 Figure A1 is preferably a one part plastic molded part complete with ½ hinge. The chamber cover of 16 in FIG. 1A lid part 28 is preferably a one part plastic molded part complete with ½ hinge. One complete hinge is formed when part 17 and 28 are meshed ½+½ together like door and frame hinge by using a force thru inserted hinge pin that is then un-removable where the pin has a key, barbed, and/or rough and/or glued at the beginning or end of the hinge pin

Located approximately 6 mM more or less in front of the pin or axial of part 28 and 17 and on the top surface of 17 is a rabbit hole with a bottom pit with silicone inside the hole that is compressible and expandable above and below the top of the hole as a way of 28 compressing it like a spring then popping open lip 28 upon release using 30 and 29 to suddenly release 28.

Alternatively any spring method in the rabbit hole can be used to pop the lid top 28 upon clip release 30 and 29.

Part 29 is spring loaded just under the plastic button as the button is located on the top side of 29's middle point axial where the opposite lower half of the axial point of 29 is the hook that will slide down the wall of 30 then slightly rise then suddenly clip over and into the female hook hole 30 located near the bottom of 30. By pushing the upper half of 29 button it will lift and release the hook from 30 female hook hole. Preferred, part 30 will be moved to the position of part 29 and part 29 then moved down to the position of 30. Button 29 on bottom is a more effective preferred spring pop release of 28 hood.

Preferably the top surface of part 28 will have a thru cylinder in the roof center of 28 and bulb 31 both so it can accept an inserted FIG. 1C temperature chamber gauge monitor with a visible plastic dome window 12 placed at the top surface of the roof of 28. The housing of the temperature gauge FIG. 1C holds 12, 33, and 34 and it will have a glue flange glued and recessed into the top surface roof of 28 with finish ring edge cover. Part 31 will have enough material to seal against 32 recessed compression rim as lid 28 is shut to make it to air and waterproof seal 16 insulin chamber. The vertical metal shaft attached to 12 temperature gauge will be different lengths depending on need for more or less length for us in a deep plug or thinner screw cover cap. As seen, the thermal wire and/or coil 34 is located as close to the 16 cooling chamber as possible to pick up temperatures and monitor insulin chamber temperature where 33 insulation gives time for 34 to equalize in temperature to the 16 insulin chamber's temperature. Anyone skilled in the art that makes flat surface circular temperature gauges with sealed housings similar to FIG. 1C can modify the same or similar gauge to work, fit, and seal.

Bulb 31 will preferably be like a stiff compressible rubber hand ball material or alternatively silicone that will compress to air and waterproof seal chamber 16. Bulb 31 is friction or glue held in place by the pass thru cylinder of FIG. 1C.

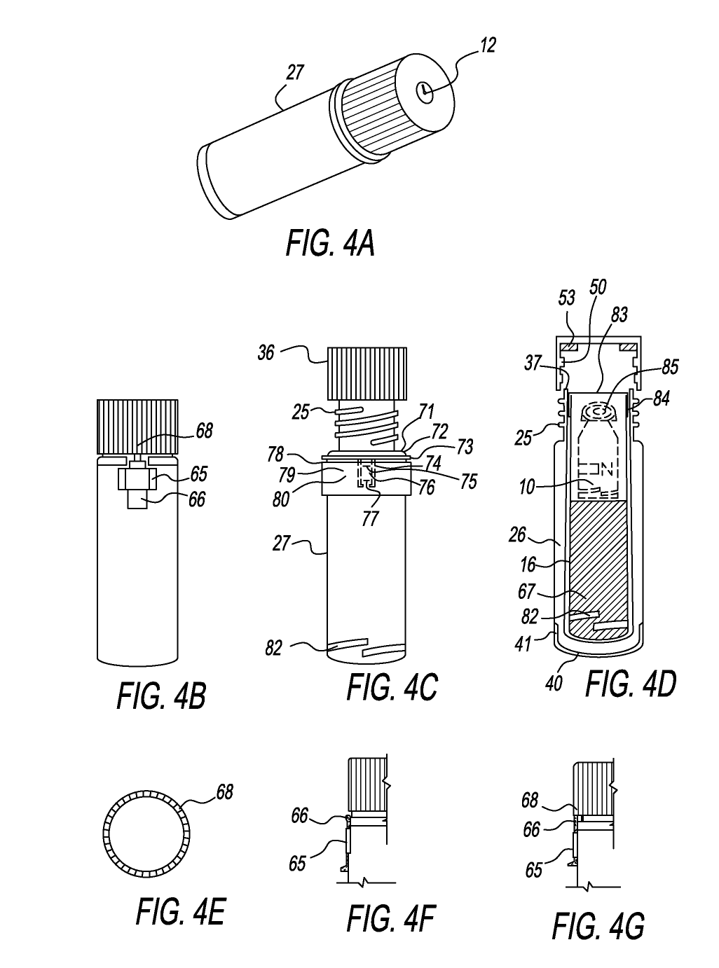

FIG. 1F is a plug to seal shut bottle FIG. 1B so it can carry extra ice or ice water when not using FIG. 1A and the plug has an adaptive part 81 to carry a screw in tube upside down to chill it. (See FIG. 4 and note 82 threads) Preferably, carry backup icy water and chill tube(s) like 67 and FIG. 4C. Empty bottles used to retrieve water and ice at stores and restaurants will work just fine too. Rotating two bottles, screw FIG. 1A away from a warm used bottle to a new second colder chilled bottle as this is a preferable method.

### DETAILED DESCRIPTION

### FIGS. 1A to 1F

Use It

FIG. 1A, 16, slide small or large insulin bottles needed for the day or longer into chamber 16 and push down the top 28 lid until it clips shut 29 and 30. Take FIG. 1A and place the line 20 even with the top of the bottle rim, like 37, making sure the water is filled just about ⅛ of an inch under the bottom of the chamber 16 tube end. Preferred bottles like FIG. 1B will have a water level indicator visible by just looking on the inside of chamber 24 with level marker permanently attached or melded or color indicated inside the 24 chamber. Water overflow displacement will be prevented by starting with the correct water level before inserting FIG. 1A into chamber 24 where FIG. 1A is then screwed into the bottle FIG. 1A, 18, 19,22, and 23 as a plug seal to chamber 24. After a few minutes look at the temperature on the top of 28's roof and/or FIGS. 1D and 1C. If you want it cooler, unscrew plug chamber 24, pour out some water to make additional room and then add some solid small ice cubes and/or add 32 degree ice water as this then refills chamber 24 back to the correct water level. Ice can be made smaller by placing it first in water or fill the ice tray only to half way before freezing ice tray. You are good to go and travel and you will look like a person carrying a thermal bottle (simulates, coffee on the go) after you screw on top 70, it's a finished thermal bottle ready to go.

It's a warm morning 8 am and it is 85 degrees, and the car is 110 degrees and I want to protect my insulin for 60 days traveling on dessert roads in Arizona living in motels with the insulin always near me for insulin injection shots to control my blood sugar levels at all times and meals, snacks, and/or as sugar levels are tested 2 to 8 a day and on the road. My insulin will not be reliant upon ownership of an electric refrigerator or a horne most any place I want to travel. I will be using FIG. 1A and bottle FIG. 1B to manage cool insulin supplies for me for 60 to 90 days or more at desirable temperatures of, 36 to 60. My goal preferred is to extend the bottle of insulin's life beyond manufacturer's suggested 21 days at temperatures at or below 87 degrees and more so my goal of insulin care is 60 days or more of cool storage of insulin stored below 60 degrees consistently known to me by a temperature monitor gauge, FIG. 1D, with insulin degree temperature standards to be 36 to 60 for longer lasting quality insulin care. Also, if using smaller bottles or tubes with only 5 days of insulin supply, I can carry this smaller amount of insulin on my body consistently at or below 60 degrees and it's all used up well before 21 days, so I am using quality insulin supplies on the road while the remainder can be in a larger bottle to last 3 months. I'm only guessing insulin temperature estimates without a temperature monitor gauge so I need the gauge to find out if my insulin bottles, pens, and other insulin products I keep are cool and safely stored. 12 gauge FIG. 1C or 1D temperature monitor is important to manage my insulin at known beneficial temperatures.

Alternatively, temperatures below about 36 degrees make insulin thick or clumpy as undesirable FIG. 1D and freezing of insulin is not allowable starting at, near, or below 32 degrees more or less. Experiencing cold whether hiking up Mt Rainer, I bring a small burner or torch to heat water to place just enough additional heated water in chamber 24 to raise temperature to 70 degrees in this extreme weather case and I bring a second thermal bottle with 212 degree water with me from base camp. This occasional small heat application will prevent the insulin from cooling down too fast and warmth will prevent freezing chamber 24 while standing on top of Mt Rainer or I'll be descending the climb 6 hours before the next bottle warming or cooling application occurs again in chamber 24 at the lower return elevation were temperature could be 17 degrees or temperatures in the car to be 80 degrees driving down the mountain toasty warm. Also insulin in a plastic tube in a pocket close to or on body heat will help keep insulin from freezing on a cold hike. Necklace and tube or 67 hung around the neck is a source of replenish able body heat too. As noticeable, diabetics activities just enlarged to wider ranges of temperatures with insulin at less risk in many different environment temperature conditions in doors, out doors, car, and many other possible travel destinations in life and living life. Preferably, cool water, ice, or warmed water is available to manage chamber 24 temperatures so insulin can be protected any place I go. I understand chemical pills exist that once dropped into water they will chemically react to raise water temperatures in chamber 24 as this could be useful in cold weather hiking conditions. Also, warming 67 on or near skin or body will add enough heat as a warm up from time to time in a potential freeze condition for insulin in a tube.

Ice, ice water, and cool water in any differential added and subtracted combinations causes the final mixed water temperature result to arrive at the desired starting or maintenance temperatures in chamber 24. FIG. 1B, 24, so one way is to add 10% tap water (40 degrees) to chamber 24 (City, County, Well, etc) and then add 90% 32 degree ice water made in a separate container or from a restaurant or secondary supplied thermal bottle, a 10/90 mix, (Tap and Ice Water) with no solid ice added this time. If you are in a hurry, short term draw some cool tape water at usually 60 degrees in temperature (Seattle Wash.) as this is better than nothing in a hurry and the car is at 110 degrees as 60 degree water is a time and temperature stabilizer for a time and it's much better than nothing or 110, because it's hot out in the car on the way to work or play before I reach the water cooler at my destination to re-cool the bottle with insulin in a chamber now 65 degrees. So, load FIG. 1A in filled bottle 1B and go and then adjust temperature as need be a short time later by adding ice or finding refrigerated water to replace the 60+ degree tape water at a place were you arrive shortly. If starting at 60 degrees, monitor temperatures every 30+− or as needed minutes to re-cool it before it's an emergency over heat. It's a flexible system that adapts to were you are going and at many places on the way. Bottle the insulin and Go! If blood sugars get too high or insulin shots are needed before meals are eaten like they often do, safely stored insulin is always available to draw a shot and inject the insulin.

FIG. 1E. Adjust the temperature in chamber 24 after it reaches 60 to 65 degrees by looking at FIG. 1D as this will occur in approximately 3, 6, 8, 16 hours or days later depending on the bottle's outer atmospheric temperatures that are extremely dependent on many environmental heat or cold factors while on the road of life. The good news is chamber 24 can be managed using FIG. 1D in timely temperature action care of insulin almost any time and anywhere you go. It's a good idea, unless it's a baggage burden, to have a second small or larger thermal bottle loaded up with ice aided by a standard FIG. 1F thermal bottle plug or cap. A secondary thermal bottle is a handy available convenient way to replenish cool temperatures or warm up temperatures for the benefit of the insulin storage bottle chamber 24. An empty thermal bottle will collect ice and water in a restaurant to take back to a car to use it to re-cool the various Embodiments FIGS. 1, 2, 3, and 4. Heated water applications can be applied in chamber 24 bottle as manageable to counter outside weather temperature below 32 degrees pushing it to freeze inside chamber 24. Hot weather is the usual situation and the beauty is cool water and/or ice sources are available most places you carry your insulin in the MISC, like: a fast food store, fast food restaurant, office, rest stops, school, home, plane, stadium, water cooler, portable car refrigerators, backpack, bike, purse, briefcase, sport bottle bag, boat, camper, ice chest, river, lakes, glassier lakes, outside hose, ocean, parks, drinking fountains, snow fields, etc. No more problems with hot insulin or blue ice all melted and hot or problems with bulky embarrassing unsightly insulating contraptions, or your insulin is left at home because of risk of damaging a $100 bottle of insulin in hot weather, but you now need your insulin, because you actually ate food like everyone else does and enjoys. How many times has this occurred to break the diabetic's basic life enjoyment of all the above? No more! A cool 24 chamber recharge is almost always available in short time and short distance almost anytime or anyplace using my inventions and it looks like any socially acceptable coffee or drink thermal bottle, sports bottle, etc. The diabetic is no longer dependant upon bulky coolers, bulky unfashionable insulating bags or ice chest boxes, or the need to waste time to return to that bulky refrigerator too many miles away and inconveniently unavailable right now when it's needed the most for your insulin. No longer waste hours and hours of time waiting to refreeze blue ice systems hours later to again resume life and travel, because this new invention only really needs (cool or warmed) water availability at many places on the go and that's what makes this system work so effectively on the road of life. FIGS. 1A and 1B and other embodiments FIGS. 1, 2, 3, and 4 are compact, and they go basically un-noticeable and it responds and it mobilizes almost any time and place a diabetic wants to go on short notice. Also, when a refrigerator is close by and you do not want to use the preferred thermal bottle 1B, remove FIG. 1A from the bottle as 1A is relatively streamline and compact with its protective tube storage walls, so next place FIG. 1A with loaded bottles of insulin inside the refrigerator for cool storage were there is no immediate need for travel and mobility. FIG. 1A is great for use inside the refrigerator loaded with insulin supplies. FIG. 1A is ready to go with you in a bottle FIG. 1B on quick demand set up and you manage the temperature on the go on the road of life almost anywhere or anytime cooling water or ice is available and found.

Need ice in a restaurant. Remove FIG. 1A from bottle and place the insulin bottles in a safe cool insulating tube or cool second bottle. FIG. 4C. Leave car to go to restaurant to get ice and water using just FIG. 1B bottle as this will draw no unusual questions, because it is the usual looking thermal bottle in most all ways without FIG. 1A. Do not leave insulin in a hot car unprotected or unmonitored to then not know the insulin temperature in the 16 chamber, if, or how fast it is heating up. Rotating FIG. 1A from a warmer bottle to a new chilled FIG. 1A bottle is a preferable method.

The second spare bottle goes without need of FIG. 1A taken into a public place, as this does psychologically matter to many diabetic's privacy to avoid nosy questions, as FIG. 1B is being filled and chilled.

### FIGS. 2A to 2D

### Second Embodiment

### Make It

The Second embodiment of the invention Mobile Insulin Storage Cooler or (MIS C) is illustrated and demonstrated in FIGS. 2A to 2D.

FIG. 2A is a perspective view of an inventive bottle that has the insulin chamber entrance 38 built into the bottom of the bottle. The bottle is accessed by way of preferred bottom screw cap or any other alternate possible cap or plug type that benefits bottom entry of the bottle and insulin chamber is acceptable. The bottom cap is generally illustrated in the cut away drawing of the bottle's lower half, FIG. 2B.

This bottom entry insulin chamber bottle can be designed to fit within any new and/or existing bottles with space for 38 and these bottles need only have ability to be carried in one or two hands by a reasonably healthy people with normal coordination so they can carry the enduring preferred Stainless Steel Vacuum Sealed multiple wall Thermal Bottle same, like, or similar to FIG. 2A that stores cold or warm any safe useable thermal mass liquids and/or solids, preferably water in chamber 24, at cool or warm beneficial temperatures for the purpose of beneficially extending insulin life by transference of cool or warm storage mass into insulin bottles, insulin pens, insulin pen cartridges, and/or various other insulin products that are available, or any alternate uses to extent the life of any perishables that can fit inside chamber 16 or 38, or drinking spirits and alcohol, human or animal tissue, cells, and parts, and any other medicines recommended maintainable at cool or warm insulated temperatures, preferably, for as long as portable thermal bottle at lasting beneficial desirable temperatures.

It is also possible for short term cooling or warming use needs of (MISC) where the bottle(s) need not have long extended lasting thermal qualities because of the customer's specific travel need(s) of (MISC) were any fitting bottle material or bottles made of plastic, glass, single or multiple wall, or any fitting hand held portable bottle will serve the cooling need(s) long enough to fit the customer's needs, Any bottle can have outside bottle insulation added and/or removed as customer needs while using any handy mobile bottle by adding an insulating bag or any bottle slip-on foam rubber insulating cozy, with or without zipper, etc,

FIG. 2A chamber 38 is built into the bottle as a Stainless Steel preferred material or use any alternate material(s) that will conduce cold or warm temperatures from chamber 24 then thru the walls of the insulin chamber 38 and/or then thru thin wall chamber lining 16 at a rate sufficient to constantly cool or warm but not freeze the bottle(s) of insulin inside liner chamber 16 to about or equal to the temperatures maintained and managed in chamber 24 FIG. 2A at insulin storage temperatures suggested by industry for insulin at, but not limited to, 36 to 87 more or less degrees using material preferred to be thin wall plastic liner for chamber 16 and to be preferred SS wall material for 38 chamber. Preferred Liner material 16 to be of plastic bottle and/or cap material like pop bottles and/or plastic sports bottles. PVC pipe material or similar qualities material look appealing for use as a 16 chamber liner.

Wall thickness of chamber 16 to be any thickness sufficient to cause timely and sufficient cooling conductivity and it will also be semi-insulating with surface finishes that discourage condensation events as preferred but it's not a requirement to use the 16 liner if the customer does not want it. Wall thickness of chamber 38 will have durable wall quality favorable to bottle structure made of preferred Stainless Steel 1 mm+ thick or approximately 1/64 more or less of an inch thick. Chamber 38 will house insulin chamber liner 16. The walls of 16 chamber preferred to be about 1/16″ minus or less inches thick of plastic.

Any hole diameter, length, or multiple hole chamber combinations that stores one insulin product or multiple insulin products can be used as long as it is desirable to the customer's needs and as long as it can be made to fit into the bottle as Chamber 16 will have a preferred built hole size of 15/16 more or less inches in diameter and it will be a 6⅜″+− deep hole to preferably accommodate three standard size 10 mL volume insulin bottles and they have a preferable entrance hole rubber plug in the entrance bottom part of chamber 16 and/or 38 chamber will house this all once sealed shut as the bottle will then be standing up right. Chamber 38 will accommodate the thin wall removable storage chamber 16 with it's cap shaped like a nipple to accommodate the head down inner insulin bottle. As chamber 16 and 38 are screwed shut, the chambers will be air and waterproof as 44 compresses against 49 and compresses against other multiple angular and flat surface edges.

The preferred method to make and manufacture plastic bottles, vacuum sealed stainless steel thermal bottles and the parts that go with them will be accomplished by any person skilled in the art to which the invention pertains to make them. I see by observation that the single or multiple wall bottles have (plastic or metal) semi-unnoticeable seams as separate parts welded, glued, heated, and/or melded and sealed together to become one finished part and then sometimes those parts are again melded with another part, etc. and finish capping occurs in many ways and places to hide seams were the human eye is most focused in study of the final product.

Observing FIG. 2C cross section, I see making the top cap 36 preferably multiple wall Stainless Steel 26 vacuum sealed, yet any cup material with some isolative quality is acceptable. Gasket 53 will be thin or thick enough to any durable material (preferably plastic) for lasting daily use and it will seal waterproof tight and it will be backed up by surrounding plastic structure held inside the cup by compression fitting 51 stem. 52 is a stainless steel finish plat over the heated stainless steel subsurface below it. 50 and 25 are threads screwing down the cap forcing 37 to seal against 53 so that nothing will then leak out of chamber 24. Preferred, like FIG. 4C 36, 71 to 80 so too can FIG. 2C 36 and/or 43 be made to lock the caps in place to guarantee a 78 locked seal will stay during mobile transport, but an alternative less expensive caps with or without lock system can be used. In backpacks where cap friction can cause a cap to become loose, 78 locks are preferred. Preferred, the bottom cap can be made similar out of multiple wall stainless steel walls as thick as the top cap 36 vacuum sealed or it alternatively may be made as drawn to be any material durable like plastic bottle cap material used in the industry. 44 is insulation and a gasket sealer formed to snuggly fit the head of an insulin bottle 10 mL or the chamber liner 16 head preferably and to air and water seal against 49 when screwed shut. 42 and 39 are threads screwing down the bottom cap forcing 49 to seal against 44 rubber gasket that seals out air and water and 44 provides some insulating properties as preferred or any other materials that does the same or better as said. For this embodiment, I prefer the parts 45 and 46 to not be installed and then, have the hole sealed with a removable push plug and/or said plug hole can be part of 44 as an insulation barrier between the hole and the insulin bottle head. See Alterations for use of these parts, 48, 45, 46, and 47 used in conjunction with an insulin pump.

In FIG. 2D the vacuum seal will occur in the bottle walls 26 as the air escapes holes in and at the area of 54 occurring at desired vacuum seal heat temperatures. Holes 54 are just below the finish plate 41 as 54 is welded or molded shut after air spaces. As the bottle cools, the vacuum occurs to cause the insulating effects and at the same time the vacuum does not compromise bottle structure integrity yet any vacuum seal method that does the same is acceptable to cause the desired vacuum insulating effect. This vacuum seal methods applies to all the embodiments FIGS. 1, 2, 3, and 4,

Preferably the top surface of cap 36 will have a center thru cylinder like FIG. 1C welded or melded both sides of the walls to keep the vacuum seal 26 maintained in the 36 cap and between the walls. Said cylinder may be centered or off centered passing also thru 53 to then be inside 24 chamber to monitor temperatures in chamber 24 as FIG. 1C is sealed into that thru cylinder. Temperatures at the bottom end of FIG. 1C in chamber 24 will usually be equal to chamber 16 and/or 38 chamber temperatures. FIG. 1C is same or similar to show and demonstrate a temperature gauge used in said cylinder so that anyone skilled in the art that makes flat surface circular temperature gauges can make or modify a gauge to work, fit, and seal into the roof top of 36 and into chamber 24 sealed waterproof or FIG. 1C to fit into cap 43 at or near 47 to monitor temperatures directly in chambers 16 and 38. Any temperature location that benefits insulin storage maybe used.

### FIGS. 2A to 2D

### Second Embodiment

### Use It

FIGS. 2A to 2D, the second embodiment is used and managed in almost the same way as FIGS. 1A to 1F as the preferred embodiment. Please read First Embodiment then read on about embodiment two. FIG. 2C is built a bit different so it is used a bit differently than FIGS. 1B and 1A and it is possibly more costly to produce than the first embodiment but the second embodiment does the same with added privacy easily achieved while in use. Water goes in chamber 24 in FIG. 2A and the cap 36 is screwed on as 37 and 53 seal it waterproof using threads 25 and 50. Remove cap 43 and place insulin or other bottles in chamber 38 in with liner chamber 16 if liner is preferred with insulin bottles with one bottle up and one down. The down side bottle custom fits into 16 liner cap and 44. Screw the cap 43 shut and it air seals 49 against 44 using threads 39 and 42 to screw the cap on.

This bottle FIG. 2A system has some privacy in an office work situation or directly in public places to refill the chamber with cool water without having to remove wet outside chamber FIG. 1A as no one will hardly sees the built in part 38 of FIG. 2A in a public place when cap 36 is removed inside say a restaurant right at the pop and ice machine while around 5 other people waiting for a cool water and ice fill up. The shorter 38 is the less noticeable it is or if 38 is moved toward the bottles inner walls it semi-disappears.

Filling 24 chamber of FIG. 2C is simple. For privacy, not before, but at the ice machine, remove cup 36 and then quickly tilt it and move it to the ice and water machine and in this way no one will ever see 38 and once full cap it quick with 36. Uncap, fill, cap all quick like right at the pop and ice machine. Another way is fill any cup with ice and water and then transfer ice and water to bottle 2D in some place semi-private area, by the car, etc.

Altered, cap 36 can even double as a water source all day with water level maintained close to full capacity. Industry may want to first test Market FIG. 1A for marketability, because FIG. 1B does not need to create a whole new mass produced thermal bottle. FIG. 2A, 38 chamber is not removable and it is helpful to have a second 16 storage tube inside chamber 38 to assist quick in and out of insulin bottles using a liner-tube 16. This aids quick movement between thermal bottle and refrigerator storage. The 16 liner is positive and handy to use. FIG. 2C is not convertible back to a standard thermal bottle.

FIG. 2A has no overflow bottle problems and no special needs for water level observations, because its insulin tube is already occupying the bottle during water fill up. FIG. 2A cup 36 can have a suck nipple like a sports bottle for water usage all day and no one will ever hardly notice that it stores insulin products in the private bottom access to the insulin chamber. Alternate caps or plugs like the top load bottle FIG. 1B can also be designed for the bottom access of FIG. 2C. The temperature monitor gauge of FIG. 2C is in the top cap of cup 36 FIG. 2A or the gauge will be near 47 part location in the bottom cap or use temperature gauge in any other useful locations to benefit insulin storage.

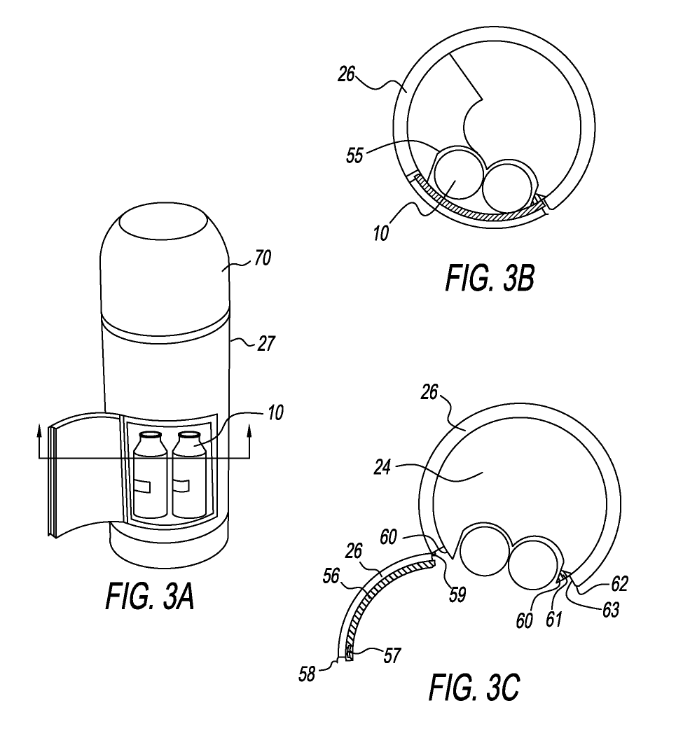

### FIGS. 3A to 3C

### Third Embodiment

### Make It

The Third embodiment of the invention Mobile Insulin Storage Cooler or (MISC) is illustrated and demonstrated in FIGS. 3A to 3C.

FIG. 3A is a perspective view of an inventive bottle that has the insulin chamber and wall 55 built into the side of the bottle as the chamber is accessed by way of an air sealed side door. Any type of door and compression locks can be added to the door and slip covers can also be added to seal and insulate the door. This side entry door can be modified to fit any new and/or existing bottles that have ability to be carried in one or two hands by reasonably healthy people with normal coordination carrying a preferred thermal enduring Stainless Steel Vacuum Sealed Insulating Thermal Bottle same or similar to FIG. 3A or similar FIG. 1B that stores any safe useable cool or warm mass liquids and/or solids, preferably water, at cool or warm temperatures for the purpose of transference of cool or warm storage temperature life into insulin bottles, insulin pens, insulin pen cartridges, and/or various other insulin products that are available now or future, or the insulin chamber can be used to extent the life of human or animal tissue, cells, and parts, and it will extend life of other medicines beneficially maintained at cool or warm insulated temperatures, preferably, for as long as possible in the bottle or tube, as need be to benefit long biological life in a manageable thermal bottle.

Using any bottle and chamber materials, it is also possible for cooling or warming use needs of (MISC) where the bottles need not have SS multiple wall lasting vacuum sealed thermal qualities because of the customer's specific travel need(s) of (MISe) were any bottle material that can fit or accommodate 55 chamber so then the chamber or bottle can then use any bottle type material like plastic, glass, single or multiple walls. as long as the bottle is hand held portable and it will serve the cooling or warming needs managed by the user for benefiting enduring insulin or biological life and any bottle can be used with outside bottle insulation added or/and removed as customer has needs for insulin care by adding or removing a thermal bottle insulating bag or adding a bottle slip-on foam insulating rubber cozy, with or without zipper, etc. These slip on bags or covers can alternately be a substitute replacement of the doors or covers or it can add to and enhance the door's insulation in FIG. 3 or covers will keep bottles thermally insulated and the covers will prevent insulin from falling out, if doors were removed and replaced by a slip on cover, bag, or similar. Preferably, I like the doors in FIG. 3 or any doors similar to seal the cool chamber 55.

FIG. 3A to 3C chamber 55 is built into a multiple wall vacuum sealed bottle using Stainless Steel preferred or any material(s) that will conduce cold temperatures from chamber 24 then thru the single wall of 55 directly to the insulin bottles or Stainless Steel wall 55 first then thru a thin chamber plastic wall lining and then to the insulin bottles as preferred were the cooling or warming rates are sufficient to constantly cool or warm but not freeze the bottle(s) of insulin inside 55 medicine cabinet. Medicine cabinet with Liner 16, where insulin temperatures usually will be about or equal to the temperatures maintained and managed in chamber 24 FIG. 3C at insulin storage temperatures of, but not limited to, 36 to 87 more or less degrees. The preferred thin wall chamber plastic liner 16 will be waterproof using preferably plastic bottle and/or plastic caps materials. PVC pipe material or similar qualities of material look appealing for use as a 16 liner material against wall 55 if need be to control condensation on the metal wall of 55.

Wall thickness of liner 16 to be sufficient to cause timely and sufficient cooling conductivity coming from wall 55 and it will also be semi-insulating with surface finishes that satisfactorily discourage condensation events. Wall thickness of chamber 55 will be any thickness having durable wall quality favorable to bottle structure or preferably make it of Stainless Steel 1 mm more or less thick or approximately 1/64 more or less of an inch thick. The walls of 16 chamber liner to be about 1/32″ inches thick of plastic if need be or any thickness that stops undesirable condensation in chamber 55. The liner will slow down the loss of cool or warm mass in 24 chamber while it also provides enough cool or warm mass transfer to be sufficient and beneficial for desirable insulin storage.

Any size medicine side wall chamber 55 maybe used for insulin storage products or other said storage products described in all embodiments or alternate products can be used in determining sizing length, height, circumference and recess depth of the medicine cabinet in wall 55. Cabinet size can change to accommodate multiple insulin product storage in any number and/or or combination of insulin products that can be stored to fit, on the walls of the customer's hand held bottle large, small, or tiny bottle as long as insulin chamber can be made to fit in with chamber 24 space, yet preferably to be as shown are two 10 mL insulin Bottles in FIGS. 3A to 3C that fit into a Medicine cabinet measured 1⅞″×2¼″ and cabinet is deep using 10 mL insulin bottles and this cabinet will fit, weld, and/or meld into the inner wall radius of the bottle. On the outer upper wall, the stainless steel wall will open to be ⅛″ larger around the perimeter of the 1⅞″×2¼′ inner wall medicine cabinet then the upper surface metal wall will preferred fold down making an edge 63 wall (or add down preferred stainless steel material) to touch the surface of the inner bottle wall where it will be welded and/or melded to the inner bottle and all remainder seams and edges will also be welded and sealed shut, as this creates an edge 60 for the door to fit into and the door has an edge to seal and rest upon. Position and weld attach the spring loaded hinge 59 into the recessed outer bottle surfaces and weld attach hinge 59 to the SS vacuum sealed door with a surface recess for the hinge. The stainless steel bottle can now be vacuum sealed just like it always is in the standard vacuum sealing method know to the artists of the industry. Next, adhesive, glue, or attach the 56 padding to the back side of the small door to air seal the small door when the door is closed to rest upon recessed bottle edges 60 as the pad is a material used to magnetically seal a standard refrigerator door, but any material that does the same or better function can be used. See 57 interior padding magnet at door edge or use magnets full perimeter on all edges.

FIG. 3A chamber 24 will have a top plug like FIG. 1F with a temperature meter installed thru the top of that plug that will expose the lower 34 area to be thru the bottom of plug FIG. 1F. This temperature gauge will monitor the temperature in chamber 24 and this will closely match or equal chamber 55 temperature. Any temperature gauge type or location that benefits the insulin's good care is acceptable. Anyone skilled in the art that makes flat surface circular temperature gauges with sealed housings similar to FIG. 1C can modify or create a gauge to work, fit, and seal waterproof into and thru the top center of FIG. 1F. FIG. 1F screw seals chamber 24 located under the screw cap 70 of FIG. 3A.

The Preferred method to make and manufacture plastic bottles, vacuum sealed stainless steel thermal bottles and the parts that go with them will be accomplished by any person skilled in the art to which the invention pertains to make them. I see by observation that the single or multiple wall bottles have (plastic or metal) semi-unnoticeable seams as separate parts welded, glued, heated, and/or melded and sealed together to become one finished part and then those bigger parts are sometimes melded again with another part, etc. Artful finish capping occurs in many ways and places to hide the noticeable seams were the human eye is most focused to study the final product.

### FIGS. 3A to 3C

### Third Embodiment

### Use It

The Third embodiment of the invention Mobile Insulin Storage Cooler or (MISC) is illustrated and demonstrated in FIGS. 3A to 3C.

The third embodiment is maintained and used the same in its cool or warming mobile uses in the same way as FIGS. 1A to 1F as the Preferred Embodiment, but it has a side 58 door in the bottle.

Get a fingernail to enter under seam 62 and hook 58 and pull the door open free from the bottle edges 60 and 63 were pad and magnetic attachment system is located at all door seams or magnets 57 that are just by the door opening seam. Open door to put insulin bottles in and then close the door to cause the chamber to become and stay cool. It's the Mini Mobile Refrigerator or MMR, not electric. Cool thermal transfer from cool mass in the water chamber will transfer through wall 55 and into the insulin chamber cooler. Keep the refrigerator door 58 shut to no let the cold out and the heat in, because an open door will shorten the cool life span of chamber 24 mass that will warm with the door open to expose 55 wall or everything to warmer outside air.

If in public and you want to hide the door on the thermal bottle, just slip a fancy or plain Jane water bottle bag over it or use a beefy shoulder strap to carry it all. The bag I invented by experimenting also works well for single wall frozen sports bottles to cool insulin bottles separated by a semi-insulating wall between insulin bottle and the frozen bottle. Want total privacy free of public questionnaires? Use the provided easy on and off foam insulator bottle cozy or use the slip on cover to cover the bottle doors as you go to a restaurant for Ice and cool water to fill up chamber 24 just like or similar to the other embodiments. The temperature monitor gauge is in the screw plug FIG. 1F located under cup 70 of FIG. 3A. Properly sealed Chamber 55 temperatures will be same or close to chamber 24 temperatures. A temperature gauge can be added to the door to chamber 55 or add a temperature gauge anyplace to benefit insulin care.

### FIGS. 4A to 4G

### Fourth Embodiment

### Make It

The Forth embodiment of the invention Mobile Insulin Storage Cooler or (MISC) is illustrated and demonstrated in FIGS. 4A to 4G.

FIG. 4A is a perspective view of an inventive bottle or tube that stores insulin and any other insulin products said in all the embodiments and alternative products directly inside a preferred stainless steel thermal bottle or tube 16. For more uses, use preferably bottle plastic material for tubes or any material to make a reasonably durable tube to conduct or insulate temperature changes thru the walls of the tube as those materials can be used for FIGS. 4A to 4G. Insulin storage 16 temperatures in the tube to be, but not limited to, 36 to 87 more or less degrees. Material preference plastic or SS is based on desired use and function of one, to insulate the contents inside chamber 16 or two, to conduct cooling or warming temperatures through the wall of chamber 16 and then into the insulin 10 or product to be cooled or warmed inside the 16 tube chamber. Number one is a preferred vacuum sealed 26 multiple wall stainless steel tube and number two is a preferred single plastic wall material.

Preferred SS tube Material: FIG. 4D, inside the tube is added cool or warmed thermal mass by adding 67 (any solid material, 67 material preferred is copper) inside 16 the tube where wasted space inside the tube bottle is to be kept to a minimum. Walls 27 are a preferred thermal insulating vacuum sealed multiple wall stainless steel tube with a plastic insulated screw seal cap 36 and the cap can be inventively locked 71 in place once sealed tight or any cap material can be used that air-seals and waterproofs the cap and the cap adds some insulating qualities. Wall thickness of each wall will have durable wall quality favorable to bottle or tube structure and vacuum seal ability as bottle walls are made of preferably Stainless Steel 1 mm more or lessthick or approximately 1/64″ more or less of an inch thick. Part 12 is a shallow circular water proof sealed temperature gauge (FIG. 1C) to monitor the temperatures inside the tube 16 where insulin and/or thermal mass 67 is stored. 12 seen in the top center cap FIG. 4A would look like FIG. 1C before installed, but it will not be as deep by shortening 12 center metal stem length and it will have the riser area with less thick insulation. If a larger overall length top cap is ok, make a thicker insulated cap, longer center gauge 12 stem, and have longer side walls so it's threads 50 screw with 25. The preferred tube for insulating it's tube contents is a vacuum sealed 26 stainless steel tube yet any materials that can do the same long lasting insulating quality is acceptable. The superior insulation of a vacuum sealed multiple wall insulating tubes is that it keeps it's storage contents from loosing cool or warm storage temperatures for long time periods, preferably insulin products are cool or warm while the tube is being mobilized in transit outside of the larger 24 chamber or the tube is outside the refrigerator and traveling places storing insulin with the tube's owner.

Preferred Plastic tube material: Plastic materials 26 or similar to make the tubes will be same material or material like plastic pop bottles or sports bottles caps that are to be sufficient to cause timely and sufficient cooling or warming conductivity thru chamber walls and walls will also be semi-insulating with surface finishes that satisfactorily discourage condensation events as a preferred plastic material. Single wall thickness of chamber 24 or wall 27 will have durable wall quality favorable to bottle or tube structure with preferred wall thickness of 1/16th of an inch or any thickness so long as thermal and structural wall qualities are maintained. This semi-insulating cool conductivity tube is desired as a preferred insulin storage tube used inside a refrigerator and/or inside a wet 24 or dry chamber that is conducting cooling or warming mass thru it's walls. The plastic tube like the SS tube has a FIG. 1C temperature gauge 12 to monitor inside tube temperatures were the insulin is stored.

Preferred use Copper Material for part 67: FIG. 4D Part 67 to be preferably solid cooper with cooper walls as shown to hold the insulin bottle(s) or any tube material can be used that holds high levels of heat calories per each gram of its weight. Part 67 will have OD threads 82 at the bottom to allow it to screw into ID 81 cap or plug like or same as plug FIG. 1F 81. The cap 83 to seal in the insulin bottle(s) inside 67 walls will be plastic and the cap will have a rubber ID compression gasket 84 recessed partially into the interior cap wall as a ring gasket that will seal against the OD walls of 67 to seal air out and waterproof the insulin bottles 10 inside 67. 85 is a rubber cap so no water will penetrate into an insulin bottle head soaked in water accidentally, because repeated needle holes jabbed thru the original cap of the insulin bottles do sometimes leak if the insulin bottles are soaked in water long-term. This is the reason for using a cap rubber 85, if insulin bottles will get soaked it helps to stop fluid leakage into the insulin bottle causing contamination. Using 85, drop bottle 10 into cool water 24, wet fishing alternative. Plastic or SS tube, FIG. 4B has a 65 underpass slide for 66 to move up and down. The head and tail of 66 are too big to fallout of slide 65, unless forced out. The head of 66 will fit inside the hole or slots of 68. The head of 66 in the 68 hole slot keeps the cap 36 from moving or un-screwing. A few bump over ridges can be placed on the bottle and one at the under surface of 66 to lock 66 in the up or down in position. Example, see 75 and 77 bump over ridges in use as another demonstrated applied bump ridge application. Plastic or SS Tube, FIG. 4C is a preferred cap lock 71 design over alternate design 65 and 66, yet any cap that locks to help prevent leakage is acceptable. 36 is screwed down using threads 50 and 25 that mesh in tandem until gasket 53 seal to press against 37 while 68 in FIG. 4E remains a little bit above 71 in FIG. 4C male part key stub. Part 72 is melded with 71, outer circumference flange 73, and 76 male key and 77 a raised ridge bump over located on the undersurface of key 76 are all melded to 72 as one part. Bump over ridge 75 is part of the bottle. As part 72 is installed downward, 77 will bump over bottle ridge 75 making 72 to not fall off the bottle in an upside down tip over. Between 75 and 77 is a distance that limit's the travel of part 72 up and down, yet the travel distance allows 71 to rise into slot 68 as 78 is screwed upwards pushing 72 up by using bottle threads 80 meshed with 79 ID threads of part 78 to cause 71 to rise and lock into 68 slot. Part 72 is separate from 78 and 72 can not move in a sideways screw direction because it is keyed into a restrictive 74 female key slot that is recessed into the bottle and below the bottle's outer surface wall and that female restrictive slot is below the male key part that is also below the ID 79 threads or ridge of part 78.

FIGS. 4F and 4G show how 66 moves into the slot in a similar up motion way that 71 will slide into slot 68.

FIG. 4D is a cross section through the thermal tube where wall 26 is all plastic or the wall is a multiple wall (⅛″ apart) 26 vacuum sealed stainless steel wall with stainless steel material about 1/64″ thick. Part 67 is any thermal mass material easily slid out of the bottle and 67 holds high levels of heat calories per gram of it's weight, but it is preferred to be solid cooper with chamber walls for use in preferred small pocket sized tubes, but larger tubes can use this method effectively too. Alternatively, extra water bottles sealed and capped can be added for cool or warm mass inside small or larger tubes like 67. A larger wider tube 67 storage cylinder will cause cooper walls near a 1 ml insulin bottle to become thicker cooper walls and as cooper walls get thicker 67 can alternatively become plastic or glass walls with any material or preferred water trapped sealed inside glass walled chamber areas. The 81 cap receiver in FIG. 1F allows the plastic tube, SS tube FIG. 4C, or 67 to have 82 screwed into 81 and tubes will then hang upside down from 81 then said tube(s) can be placed inside of a larger thermal bottle to cool or warm in cold water or icy water or warming water.

### FIGS. 4A to 4G

### Fourth Embodiment

### Use It

The Fourth embodiment of the invention Mobile Insulin Storage or (MIS C) is illustrated and demonstrated in FIGS. 4A to 4G.

The Fourth embodiment is maintained and used with some similarities to other embodiments, but it is used in different ways and with optional uses within FIGS. 4A to 4G. It has a temperature gauge FIG. 4A, 12, like all other embodiments to see and manage the insulin temperature quality inside the chamber tube like FIG. 4D. This system is flexible in many uses and in many ways:

A. Want a safe and semi-private way to store insulin in a refrigerator by using refrigerator space extremely well. Have less people constantly moving insulin bottles out of their way, falling, and breaking on the floor. With or without the locking system 71 to 80, stuff insulin bottles in the white plastic tube and preferably screw cap it shut (any sealing cap or plug will do) and place the tube FIG. 4A to D next to a side wall on a shelf inside the refrigerator. The tube is now out of the way and it can hold many insulin bottles using long tubes. Short insulin tubes will fit customer needs great too. A white tube goes almost un-noticeable and it's out of the way and ready to use by the diabetic. Tube color can be added plus add artwork for refrigerator tubes with style, if it's what the customer demands.

B. Refrigerator storage tubes FIG. 4A to D can be made with insulating quality stainless steel tubes polished SS shiny or colored with the caps 36 set loose or open to allow the cold air in to cool insulin bottles 10 in the 16 tube. Preferably use the pre-cooled insulating stainless steel tubes 26 outside the home environment for mobile transporting of insulin products inside the tubes by transferring cooled insulin bottles 10 or cooled thermal mass 67 placed into the SS tube for mobile transport. FIG. 4D the SS tube's multiple wall and vacuum sealed walls will last outside the refrigerator to insulate cooled insulin bottles in hot weather travels or use FIG. 4D as a storage to counter below 32 freezing insulin temperatures by inserting warm mass or warm 67 with body heat or pocket heat as need be to prevent freezing of insulin products.

C. Lock Operation: 78 is moved up and down using threads 79 and 80. In another preferred design, 78 is moved up by just pushing 78 up as 78 then stays locked in the up position to then lock cap 36 from movement as this will better maintain a waterproof seal of the cap while in transit when it is immersed in water upside down. Many other common optional closers can also seal out water too. Pull 78 down and it unlocks cap 36 so now 36 cap can be screwed open to get at the insulin bottles 10 inside. Locked caps 71 decrease risk of cap movement that causes seals 53 to move and fail then next water leakage happens.

D. The bottom of tube FIG. 4C has threads 82 so it can be screwed into the interior cap or a plug ceiling of FIG. 1F 81. Tube 67 or FIG. 4C is now attached to 81 then FIG. 1F with attachment is screwed into the water chamber 24 as the tube is now totally immersed as it is storing cool insulin bottles or products in the tube. In cool or warm water immersion, a plastic tube will cool warm insulin bottles or other water mass bottles much faster than an insulated SS tube. This is how to pre-cool bottles 10 or water bottle or 67 mass in plastic tubes on the road of life. Cool bottles are then slide into a small insulated SS tube for pocket transporting into example a restaurant or any public place for say just 3-6+− hours of cool insulin availability to be available to draw and then inject insulin. Insulin injection are sometimes taken before or after eating as blood sugar levels rise dangerously without frequent insulin shots. Notice, the larger thermal bottle did not follow me from the car or motel into the public place restaurant as a bulky bottle burden, but I still had cool insulin availability in the small pocket tube like FIG. 4 anytime I needed it. Any reasonable restroom, take out small cool insulin bottle, draw insulin, and inject. Plastic disposable injection needles with needle covers fit easily into a pocket, un-noticeable. Alternatively, if you have an insulin pen stored in a thermal bottle, take it out and use it for 3-6 hours in below 87 degree temperatures and when the pen is not in use return it to a thermal bottle like FIG. 1 or 2, 3, or 4. Pre-drawn insulin can be used and stored similar to insulin pens. In all insulin chambers exposed to chamber 16, take insulin pens and seal them in a plastic bag to protect electronics from the risk of condensation moisture. Insulin Pen Cartridges can be stored just like or similar to insulin bottles. The idea of expensive electronic pens used in immersion tubes with accidental or error cap openings that are also inside a water chamber where said chamber can be compromised, can be done but presents risks. FIG. 1A adds comfort from possible water leakage damage to electronic insulin pens and their electronics. Tubes using only solid cool mass like 67 are free of water infiltration risks once 67 is cooled and dried off to then store insulin bottles or pens in dry tubes.

E. FIG. 4D, 67, 10, 82, 83, 84 and 85 and also refer to FIG. 1F 81. 82 screws into 81 as 67 is solid copper preferably or any material that holds high levels of heat calories per each gram of it's weight. Super Heat Mass accumulators are preferred material for 67 including rubber cap sealed glass bottled water. Just like FIG. 4C 82, 67 can be attached (82 and 81) to a cap or plug and ready for cool water immersion. If leaking is ever a concern, remove insulin bottle and then separately cold immerse 67 to a preferred 32 degrees in the thermal bottle 24 chamber or immerse 67 in a cup of ice. Once 32 degrees is achieved, place insulin bottle or pens in dried 67's chamber and cap it with 83 and 84 and then place it inside the chamber 16 of FIG. 4C that is built as a SS thermal insulating bottle, vacuum 26 sealed. Because of the extra thermal mass of 67 chilled to 32 degrees, the one or more insulin bottles or insulin products inside 67 will last a longer time placed inside FIG. 4C, capped and sealed shut. FIG. 4C can be sized to fit into a person's pocket, purse, or back pack or almost anything as a person is on the go and mobile. For small tubes or bigger all it takes is a small cup of ice or water and 67 can be re-cooled and then it's good for more time as a cool thermal tube storage used in FIG. 4C for another 3 to 6 hours or more depending on maximum insulin temperatures you will allow to occur, factoring, time exposed, at X temperatures, and storage volume of insulin at risk to heat damage. FIGS. 4C and 67, is small or larger cool or warming tube storage insulin care, if need be, to managed cool storage on the road of life 24 hours, 7 days a week, as long as you want to manage it to be cool or warm.

### Alterations To The Embodiments

### Make It

There are various possibilities with regard to alterations to the Embodiments.

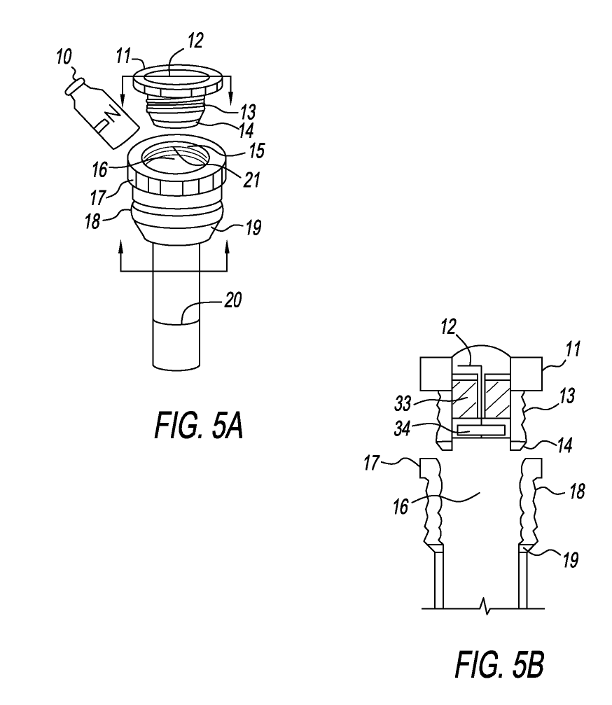

FIGS. 1A to 1F are made similar to FIG. 5A to FIG. 5B, except how the 16 insulin chamber is sealed shut and opened (flip top vs. screw plug) and FIG. 1C will have minor changes to fit gauge FIG. 1C into different thickness roof tops for each varied thick or thin roof top used as a chamber closure.

FIG. 1A can be altered to be two parts. One, the plug and two, the tube to be screwed and fitted thru the center of the plug with a washer both sides to seal it all up waterproof so the plug will not leak. In this way different length and different tube multiples and sizes can be added or switched from the original tube as this gives more variable tube options using the same plug. FIG. 1A can change from one solid part to become a two part to equal the original solid one part FIG. 1A.

FIG. 1A can be altered from a plug seal to a cap screw seal of chamber 24. Optionally, add a finish screw cup over 28 with threads on the side of 17.

FIG. 1 A. The bottom end of FIG. 1 A near 20 can be a water proof cap, plug, or any closure type opening with or without the top of FIG. 1A opening.

FIG. 1A Take FIG. 2C cup 36 with a flat top and FIG. 1A is then installed down through the top center of that cup 36 as then it becomes one sealed melded part, then put another small hinge and lockdown cup over 28 for a finished look. This would be a cap design compared to a plug design like FIG. 1 A.

Use a taller grip edge at the edge of 28 FIG. 1A with no hinges (slide Hinge and cork?) attached to make a simple push-in bottle cork (short or long) to replace bulb 31.

Top 28 can be a cap over with walls screwing to the surface of 17 and 28 can still use the bulb 31 or a cork plug works too and it could have a second wall to cover the bottle threads 25 FIG. 1 B. (Paint spray can type cap)

FIG. 1B, 2A, 3A, or 4A could be any bottle making material like plastic, glass, one wall or any number of multiple wall bottle (2, 3, 4 . . . ) to be any bottle like sports bottles or coffee thermal bottles with or with out added thick insulation and/or add to bottle thin or thick bottle bag holder wrap and attach a carry strap to the bag. The carry bag thin or thick can be used to carry the thermal bottle or any bottle and even add zipper bag pouches to the bottle bag for hard storage of diabetic supplies that need no cool refrigeration care. It's a medical bag, but no one sees it that way unless they get their fingers and nose in it and they start digging through your bag, not likely?

FIGS. 1D and 1C temperature gauges can be installed almost any place on any of the bottles, plugs, or caps where and how it is made most useful or desirable to benefit insulin care or biological care, etc. The gauge can be set as, one, to monitor chamber 24 temperatures or, two, a second gauge to monitor 16 insulin chamber temperatures. The gauge can use colors in gauge zones in temperature ranges that gauge temperature measures generalized as good, marginal, caution, or red hot bad temperatures. Also enter alterations with digital temperature gauges with all the bells, whistles, and alarms or programs imaginable and useful to diabetic insulin care (or alternative storage use customers) likes and dislikes to use or just shut off some of the electronic temperature monitor options.

I see a temperature gauge in the roof top of FIG. 1F as useful for many applications in insulin storage product care or for alternatives that is stored in chamber 24 or 16.

FIG. 2A will or can have a 16 liner in chamber 38. 16 liner can be two parts to make it fit compact into 38 chamber to control condensation using a flush pipe screw coupler (OD and ID Pipe Threads to screw coupler flush) to add more pipe and a cap or any open and close end. With a removable 16 liner, insulin liner tube 16 can be conveniently moved to a home or office refrigerator storage, or short-term pocket storage, purse, brief case, bag, etc. 38 chamber can be wider to accept insulin storage liner tubes 16 made of any material or length that fits inside 38 for insulin bottle storage or alternate storage. Even a multiple wall or more Stainless steel tubes in multiple shapes and sizes and multiple side by side tubes inside 38 are possible, just so long as it all can be made to fit in with many possible sizes of FIG. 2A.

FIG. 2A and all Embodiments can be altered to have one or multiple side by side chambers in the same bottle or tube with same or different lengths of chambers from the bottom up, side entry, or top down. Multiple side by side chambers can occur in any tube or bottle design of all the embodiments.

FIG. 2C numbers 45, 46, 47, and 48 as this is an alteration or option to have cool maintained insulin transferred by a tube housing 46 to a near by body strapped diabetic insulin pump. The insulin pump can be a smaller pump, because it will no longer hold onto the heat exposed larger insulin cartridges, 300 CC. Filtered air through vent 48 allows air into the solid glass bottle so insulin will flow into and thru 47 needle. plastic bag with no air in it as a better replacement to the glass inside it.) Downsizing 10 mL bottles in chamber 38 allows the embodiment to become smaller and smaller to where it is still an insulin cooler but now it fits on a belt clip of the diabetic. Also the shape of the storage bottle will change to be the shape of a thermal vacuum sealed multiple wall pocket whiskey flask, other shapes, or cool water flask with chamber(s) for insulin to be placed into cool storage inside a bottle that is body shape fitting. The whiskey flask shaped top nipple is covered with a wide cap that looks the Same preferred shape as the wide bottle, or alter not the look of a whiskey flask. Smaller plastic bag insulin bottle sizes make smaller cool storage design all possible to

supply a small insulin pump. Also, insulin can be filled loaded or transferred easily into an empty flat plastic bag thru a small nose rubber syringe bottle cap and if any air gets in the bag, air can be syringed out by tilting the bag to get air near a needle end to then get the air syringed out.

Also, the flask shape body fit bottle can be a stand alone insulin bottle chamber carrier that fits the body almost unnoticeable or it is clipped on the belt of the diabetic or similar un-noticeable to then go on the road with the diabetic as need be with no insulin pump. Sizing and reshaping FIG. 2A can be made in cylinder method as drawn, whiskey flask kidney shape, endless shapes, or the shape of a storage hinge box for reading glasses. On one end preferably cool water is added and on the other bottom end the insulin bottles preferably are loaded into cooling chamber(s). They all have outside finishing cap covers to match the shapes at top and bottom. The glasses shaped box will have fake seams and hinges added for the element of privacy to the system. Because of the wider shaped sides of a Flask or glasses case shape, one can also make a side door like FIG. 3A to have a side entry door as this is totally attainable for preferable smaller insulin bottles placed in cool or warming storage by using preferred multiple wall vacuum sealed thermal bottle insulating elements of Stainless Steel walls about 1/64th thick SS wall and vacuum chamber about ⅛″ wide between walls or size to attain fittings and insulation.

FIGS. 2C and 2D Notice 38 can be moved towards the walls right or left and also more tubes can be added in multiple lengths bottom up. Tube size will change with bottle size, yet 10 mL is the preferred size because it is the current standard used most often in industry for insulin bottles yet alternatives to smaller bottles do exist today for MD's to prescribe to diabetics to use smaller unfilled bottles to fill them for mobile uses with insulin transferred to smaller bottles from 10 mL bottles with injection rubber seal caps. Insulin can be made short in length, 1″, 1.25″, 1.5″, etc.

Bottle Size Alterations: All the embodiments can get smaller and smaller as 10 mL bottles are made available in smaller sizes like: 0.5 mL, 1 mL sizes, or larger sizes. Insulin from a 10 mL bottle is easily transferred to clean smaller empty insulin bottles like the 1.75 mL more or less serum bottle size currently available. Risk insulin on hot weather days using a 1 mL+−size filled bottle or a 10 mL two month supply outside the refrigerator exposed to the heat elements of insulin at $100 a bottle? 1 mL is less to loose or risk $10 in a safe and small portable cooler like FIG. 4D that can use down sized insulin bottles for cool storage. This makes total logical application common sense. What's more inconvenient costly and timely, being forced to emergency order a 10 mL insulin bottle because of heat damage or a damaged disposable filled 1 mL bottle? The mother ship is the refrigerated 10 mL bottle and the portable life raft is the 1 mL bottle of insulin filled from the refrigerated 10 mL bottle? Answer, 1 mL more or less preferred for best daily mobile use in tubes like FIG. 4D or FIG. 1A or others. With many disposable empty and fill-able insulin bottle sizes available, travel detached from refrigerator dependency is a wonderful new freedom to have for a diabetic.

FIGS. 2C and 2D bottom alteration. Imagine the bottom has no screw cap or the cap is permanently attached, then extend the tube 38 to open out through the bottom. Put a spring at the end of tube 38 to push on a second tube inserted into tube 38. The second tube holds the insulin bottles or products and it is insulated thick near if s top cap, but the remaining walls conduct warm or cold temperatures well to get cooled by 38 walls The top cap of the second tube once loaded will be closest to the opening of tube 38. The second tube almost plugs all areas of the 38 hole. Near the entry of 38 hole is a spring loaded clip that allows the second tube to enter, but once the second tube is past the clip, the clip springs out to prevent the second tube from falling out the bottom. A compression gasket located near the OD and top of insert insulin tube can be made to compress against 38 walls as it clips as this can then eliminate need for the other top plug seal. Use a finger to push the clip in and the pit spring will allow the insert tube to spring out or push out into your hand. Alternate seal, tube inserted, place, push, or screw a plug in that will seal up the top chamber 38. Hole 38 and seal plug will be recessed enough to not inhibit the bottom of the bottle so it will stand up straight while it rests on its bottle bottom. As long as wall 38 will conduct timely and sufficient cold thru the wall of the second tube, the insulin will then be adequately cooled. This is a fast load and retrieval method. This method can be designed top down too. A side load can also be accomplished with an insulin tube insulated on 4/15th of its radius and ⅕th of the radius un-insulated placed against the cold wall of the bottle. As the tube is loaded to a side a door would seal it all up or a compression foam or rubber would seal air leakage around the tube loaded into the side wall.

FIG. 3A has endless possible variations as a side entry insulin bottle storage application as a cool medicine cabinet or mini mobile refrigeration MMR that is cooled or warmed by water and/or ice preferably. It can be a one insulin bottle or more insulin bottles in the side entry MMR, plus it can be adapted to carry insulin pens and insulin cartridges or pre-filled insulin syringes.

Size side entry FIG. 3 chamber to Chill 10 oz more or less liquor bottles. It would be a party thermal bottle. Chilling possibilities to size and shape up the MMR cooling box and bottle to the astonishment of others wishing they had a MMR bottle too.

The door closure FIG. 3 can be hinged right, left, bottom or top. A single bottle opening door like FIG. 3 can be accomplished where the bottles are then inserted like a cartridge as the bottles enter a radius or circular chamber behind the walls or up or down behind the walls where these bottles will pick up cool temperatures off the most inner wall of the thermal bottle and in so doing a triple wall occurs were the bottles are stored. A pregnant bottle. Imagine wall 55 moving or expanding left or right behind both double walls in FIG. 3.

FIG. 3, the door can be a sliding door from the top, side, or bottom up.

FIG. 3 could have no door and then have the opening covered by a slip on cover seal (or a rubber door plug, preferred color black or gray) and insulator with zipper door access standard or optional.

For a side entry wall bottle cooler, this idea can be done to any material type bottle to cool insulin or anything else that will fit on a single wall, multiple wall, or behind the door of a single or multiple wall bottle with or without behind the wall chambers.

FIG. 4A to 4G has many various embodiment variations. The tube can be made with or without 71 to 80 or 68,65 and 66 that makes it waterproof safer but with more possibilities of leaks if the cap moves, because the tube has no lock.

Many plugs and many other closers are available that can be waterproof sealers of the bottle or tube in a wet chamber. A cork push in plug is reliable, but it sometimes takes up lots of room inside the tube or bottle. But for small storage of less bottles or smaller bottles used, plugs can be useful for immersion tubes in water or liquids.

An alternative insulating tube can be a plastic tube with added foam insulation or add an insulating bag to thicken plastic tube walls for better insulation ability. The plastic insulating tube can be double wall plastic with foam insulation between walls, yet multiple wall SS vacuum sealed are preferable insulators.

Currently, 78 in FIG. 4C is moved up and down using threads and 80, yet it can be moved up locking and down unlocking the cap by 78 having one ID circumference bump over ridge ring and at the bottle surface have the bottle have two bump over ridges to hold 78 up when pushed up and to limit 78's bottom ID edge from falling once pulled down and in this way 78 will always spine free confusing some children and many adults as to how to get the cap open. Yet, read, it really is simple to see how it locks as it lifts part 72 and 71 into 68 lock holes as part 78 pushes up, bumps over the bottle ridge and stays up. PS, 72 will not spin, but 78 is a free spinning ring using the bump ridge system. Risk of leakage (mechanical or by human cap/plug error) in chamber 16 is greater with a cap sealed tube or plug seal tube stored inside liquid 24 chamber compared to chamber 16 that is only opening to the air, like FIG. 1A preferable. Wet float tubes in chamber 24 to store insulin tubes may be just perfect with many customers and some may prefer FIG. 1A.

FIG. 1A is compact for use screwed into the bottle FIG. 1B or place FIG. 1A in refrigerator storage, because FIG. 1A is so thin and compact to also fit in the refrigerator on a side wall and it's out of the way.

Tube size can change with bottle sizes, larger or smaller, to custom fit insulin bottles that will still slide inside the tube or within an inserted tube 67 mass and chamber plus quantity of desired sized insulin bottles and insulin products stored will change length of tubes made for customer needs and useful storage purposes.

Semi-unnoticeable Pocket size tubes using small insulin bottles and products are a reality that I see in theory as working and it's very useful for a long or temporary insulator for insulin product storage. A one week or more or less supply of insulin totally free of need of an electric refrigerator or longer would be wonderful during a hot summer.

Ice trays will be made to make smaller and more numerous ice cubes available in a standard shaped outer perimeter sized tray. This helps FIG. 2A, 24, or any bottle to better accept smaller ice cubes into the chamber 24 opening or use small cubed ice in a cup to cool FIG. 4D part 67. These standard looking trays can be conveniently made available by placing them in a home or office/work freezer to help make small cube ice available. Available and useable ice can increase insulating times of the thermal bottle for longer time periods inside chamber 24 by starting or re-cooling chamber 24 to about 36 degrees as the preferred starting or re-cooling temperature point. Also, crushed ice is available on the road at fast food places and stores that we all know well by the pop fountain with lots of ice. Refrigerated plastic bottled water can sometimes be a cool 38 degrees to re-cool chamber 24 and office water coolers can do the same.

Alternative: Triple and Multiple Wall Bottle: In theory a triple wall vacuum sealed stainless steel bottle will insulate temperatures in chamber 24 longer than the standard double wall vacuum sealed bottle. The longer the insulating time the better for insulin storage, because it will require to be re-cooled less often requiring less time management by the user. So, the embodiments can have double, triple, or more layers of vacuum sealed wall atmospheres. Also, what atmosphere remains in the vacuum sealed walls, let it be an Argon gas atmosphere like used between double pain windows to extend lasting insulating quality in windows or of the bottle. These longer lasting insulating bottles can be beneficial inventions to insulated cool/warm insulin care and hot and cold storage of liquid and solid consumable goods, chemical, and biological goods used by the animal and human race.

### Alternate Uses of Embodiments

Alternate uses of the embodiments are reaching beyond just quality care of insulin at temperatures of 36 to 60 degrees, especially with some minor embodiment alterations or none.

Safe Cool Insulin for Insulin Pumps:

FIG. 2C, insulin pump aid and cooler, system option 48, 45, 46, 47 or a small hole plug seal is available to not use option 48, 45, 46, and 47. the bottle is preferably altered into a smaller whiskey flask or eye glasses box size and shaped to attach to a belt buckle or similar attachment to the diabetic. To use it, for a cool direct insulin supply to an insulin pump: Remove cap 43. Screw or click in parts 45, 46,47, and 48 to the bottom cap hole as centered. Clean the end of the small preferred 1 mL or 1.75 mL plus or minus insulin bag or bottle tip with an alcohol pad. Center and insert air supply vent needle 48 in the rubber sealer of the insulin bottle as needle 47 will also do the same a bit off center inserted. In this system, if no need for a second bottle of insulin down size the bottle, flask, etc of the new shaped bottle. With insulin bottle snug in the padding 44, insert all of this into the cooling chamber 38 as it will click lock the spring loader in place and seal it shut and locked. Open valve and bleed 46 of all air by filling it with insulin and attach it to the insulin pump nipple or insert needle into the supply rubber cap of the filled-air-free-small-volume insulin cartridge, then clip lock 46 in place. 46 has a one way ball valve (cool stored insulin towards the pump) or the pump electronically opens and closes the supply gate mechanically or electronically allowing insulin into the pump cartridge with no backflow back into the 46 line, unless to re-cool it in the line 46 back and forth. Supply line to diabetic's body is blocked or shut and then pump pulls (sucks or draws like a syringe does) in a cool fresh supply of insulin through 46 to the pump cartridge and/or injection chamber with just enough to last the next 1-6 hours or maybe 4 to 30 units. Drawing only what is needed from 46 line is possible using a system of 2 gates opening and closing by electronic controls, 46 line and line to the diabetic. This is much less storage of insulin available for immediate use in hot weather than the normal large 300 CC unit cartridges at risk to heat damage stored in the pump for days. To re-cool stored bag insulin periodically, keep flexible supply line 46 attached, take similar FIG. 2C, dump 60 to 70 degree water out of 24 chamber and refill it at a public restaurant (or other) with 32 degree ice water (or use a chilled standby second bottle already full of 32 degree water and ready to use) plus add a small amount of water at 40 degrees. Reattach cooling flask bottle to belt clip. I see in theory it working real well with a new smaller insulin pump with no need for larger insulin cartridges stored on board the insulin pump. Be on the go with cool safe fresh insulin almost anywhere. Manageable safe cool insulin while the diabetic enjoys hot weather using an insulin pump with no

major unknown concerns that insulin is becoming heat damaged.

Bear, Wine, and Hard Alcohol and Entertainment Industry:

A. It's small and it's portable for home use or party use off the road. Place ice in chamber 24 FIG. 1B. Place FIG. 1A into chamber 24. Put your favorite drink, bottle, or bag in chamber 16 and close the lid and in about a short time chilled to perfection (or warmed) using no added water/ice. Prefer round diameter bottles, but a bottle and chamber can be same or altered in size and shape to fit most sized and shaped bottles into chamber 16.

B. Small liquor bottles (We provide empty bottles to fit and fill to work with the storage bottle or tube designed or slightly redesigned) can be adapted to fit FIG. 1, 2, 3, or 4 storage tubes and chambers and cooling as liquor bottles are stored on an outside chill wall 55 or behind a thermal bottle door and behind walls as it is similar to storing insulin bottles. Small bottles of various and numerous spirits are all stored in a compact thermal bottle.

C. Small diameter, short, and/or long liquor bottles are stored in tubes similar to FIG. 4 or 1, 2, and 3 and they store well in the refrigerator too. Tubes of small bottled cool liquor can be transported on the go to a destination off road or to a party or a home or anywhere people drink. Tubes will be carrying their own cool liquor mass as this will increase cool storage times while in transit to were the person will arrive sober or alive

Medical, Veterinary, Pharmacy, Biology, Oceanography, Labs, Colleges, and the Scientific Industry:

A. Embodiments can be used for anything in the Medical, Veterinary, Pharmacy, Biology, Oceanography, Labs, Colleges, and the Scientific Industry that requires some known level of short or long distant mobile refrigeration care or heat treatment care as it will fit into the same or slightly altered tubes or bottles like the embodiments used for insulin bottles and chambers. The storage chambers are mobile, hand held, and independent of having an electric refrigerator near by as it's all maintained and managed cool or heated in transit for long or short distances. This can store: Medicines, bottled medicines, eggs, sperm, tissue, germs, viruses, micro-organisms, and small body parts (Human and Animal) for surgery in need of transport in a cool or warmed protected bottle chamber with little to no water contamination added like ice boxes. Pack the storage chamber and carry it to remote places, remote countries, remote villages, remote farms, military battle fields, etc. The MMR bottle is small and light weight and it is a tube cooler or heater as hand held cool or warm portable storage on the go or stationary.

B. Labs and Chemistry: Use it as a test tube cooler or warmer in chamber 16 for any reasonable application. Insert test tube in chamber 16 of FIG. 1A and close lid to equalize to the temperature in chamber 24. (Schools and Colleges) Hiker or Camper's Survival Bottle and Tubes: FIG. 1A, 2, 3, and 4, can be filled and sealed with survival aids like: Stick matches, knife, mirror, small laser and flashlight, plastic bag, band-aids, flint, etc. or store insulin products as said before. A cool mountain stream can be utilized to cool insulin on a long back county hike for months or days when no refrigerator is available, use a cool stream to cool chamber 24. FIG. 1B stores cool water. Cup 70 could double as a cook cup or drinking cup. FIGS. 1, 2, 3, and 4 tubes and chambers can store food, medical, and first aid in safe and dry storage while camping and hiking.

Cold, Warm, Hot Chamber For Almost Anything:

Stationary or on the road, using ice, cold, warm, hot, or boiling hot water/oil almost anything reasonable can be put into the 16 chamber to store, insulate, or heat, or cool anything placed or put into the 16 chamber sealed or unsealed. Baby formula bottle warmer or cooler, foods, liquids, solids. Warm vegetables using no water in chamber 16. Any useful material or Stainless steel tube chambers 16 will work well for heat conductivity using boiling water or oil in chamber 24. The bigger the tubes or by adding multiple tubes the more food can be cooked and if it is sealed 26 and insulated it is an even more effective super energy efficient way to cook. Pressure relief valves necessary if steam or pressure built up occurs in chambers 16 or 24. Alternatively (plug it into an electric socket) add an electric heat rod built into chamber 24 from bottom side and up to keep water or oil at 212 degrees or oil at even higher temperatures in chamber 24 as then heat transfers to chamber 16 for faster cooking than non-electric. Plug it in electric, no need to keep re-filling boiling water to maintain boiling temperature in chamber 24 plus it's more convenient. Tubes can be stationary electric or travel with you. superior insulation of multiple wall vacuum sealed SS bottles, it would be very energy efficient to cook, tube steak, tube chicken, tube vegetables, tube fries, tube rice, tube stew, tube soup, etc. If the tube cooker is about the size of a table stable base weighted food blender or small or medium sized cafeteria coffee maker, it will be very versatile and functional for individual or family tube size meals. It's useful for fast or slow cooking. Any size, electric tubes or not electric, us it for small amounts of warming or cooling. Using smaller bottles chamber 24 and 16 becomes smaller and more effective for fast, less obvious, and it is more conveniently mobile to carry it in hand or in pocket.

### FIGS. 1A to 1F

### Preferred Embodiment Optional Addition

FIG. 1A needs a foam insulator wrap or sock on the male part when it is taken out of the bottle. This keeps the cold in the tube while bottle FIG. 1B is re-filled with cool water.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A bottle for cooling or warming a bottle of insulin comprising:
a first bottle of an insulating material for receiving a liquid or solid cooling or warming medium having at its top end male threads for receiving a screw on cup shaped cover; and
a second bottle of non-insulating material located within the first bottle;
wherein the second bottle has a size that can receive a 10 mL volume bottle of insulin that is to be kept at a temperature of between 36 degrees F. and 87 degrees F. by the cooling or warming medium in the first bottle for extending the storage life of insulin in the bottle which is located in the second bottle.

2. The bottle of claim 1 wherein the first bottle is a multiple wall vacuum sealed thermal bottle.

3. The bottle of claim 2 wherein the second bottle is made of a semi-insulating plastic material such as PVC that conducts cold or warm temperatures from the cooling or warming medium in the first bottle at a rate sufficient to constantly cool or warm but not freeze the insulin in the bottle of insulin inside the second chamber.

4. The bottle of claim 3 wherein the first bottle is stainless steel.

5. The bottle of claim 4 wherein the second bottle has an internal surface finish that resists condensation.

6. The bottle of claim 3 wherein a removable cover is coupled to the top of the second bottle to provide a water tight seal.

7. The bottle of claim 6 wherein a temperature gauge is coupled to the top of the removable cover for measuring and displaying the temperature of the interior of the second bottle.

8. The bottle of claim 6 wherein the removable cover is pivotally coupled to the second bottle with a hinge.

9. The bottle of claim 3 wherein the second bottle has a diameter for receiving an insulin bottle in the size range of between 0.50 mL to 10 mL.

10. The bottle of claim 1 wherein the first bottle is a right side up bottle having a first opening at its top end for receiving the liquid or solid cooling or warming medium and male threads at the top and bottom ends for receiving a screw on cover on the top and bottom ends; and
the second bottle is an upside down bottle having its opening at the bottom end of the first bottle and securely attached to the bottom of the first bottle;
wherein the upside down second bottle is adapted to receive an upside down bottle of insulin with the insulin bottle head being aligned with an opening in the screw on cover of the bottom end, and a removable push plug located in the opening in the bottom cover.

11. A bottle for cooling or warming a bottle of insulin comprising:
a bottle of an insulating material for receiving a liquid or solid cooling or warming medium having at its top end male threads for receiving a screw on cup shaped cover;
a door located in the side wall of the bottle of insulating material;
a chamber located behind the door having a top, a bottom and a side wall of non-insulating material
wherein the chamber is sized to receive at least one 10 mL volume bottle of insulin that is to be kept at a temperature of between 36 degrees F. and 87 degrees F. by the cooling or warming medium in the bottle for extending the storage life of insulin in the bottle which is located in the second bottle.

12. The bottle of claim 11 wherein the door forms an air tight seal with the side wall of the bottle.

13. A method of cooling or warming a bottle of insulin comprises:
providing a first bottle of an insulating material for receiving a liquid or solid cooling or warming medium having at its top end male threads for receiving a screw on cup shaped cover; and
providing a second bottle of non-insulating material located within the first bottle;
wherein the second bottle has a size that can receive a 10 mL volume bottle of insulin that is to be kept at a temperature of between 36 degrees F. and 87 degrees F. by the cooling or warming medium in the first bottle for extending the storage life of insulin in the bottle which is located in the second bottle.

14. The method of claim 13 wherein the first bottle is a multiple wall vacuum sealed thermal bottle.

15. The method of claim 14 wherein the second bottle is made of a semi-insulating plastic material such as PVC that conducts cold or warm temperature from the cooling or warming medium in the first bottle at a rate sufficient to constantly cool or warm but not freeze the insulin in the bottle of insulin inside the second chamber.

16. The method of claim 15 wherein the first bottle is stainless steel.

17. The method of claim 16 wherein the second bottle has an internal surface finish that resists condensation.

18. The method of claim 14 wherein a removable cover is pivotally coupled to the second bottle with a hinge.

19. The method of claim 15 wherein the second bottle has a diameter for receiving an insulin bottle in the size range of between 0.50 mL to 10 mL.
